(19) United States
(12) Patent Application Publication
(10) Pub. No.: US 2010/0134509 A1
(43) Pub. Date: Jun. 3, 2010

(54) IMAGE RENDERING PROCESSING APPARATUS

(76) Inventor: Yoshikatsu Matsuo, Tokyo (JP)

Correspondence Address: TAFT, STETTINIUS & HOLLISTER LLP, SUITE 1800, 425 WALNUT STREET, CINCINNATI, OH, 45202-3957, US

(21) Appl. No.: 12/627,078

(22) Filed: Nov. 30, 2009

(30) Foreign Application Priority Data
Dec. 3, 2008 (JP) 2008-309037

(51) Int. Cl. G09G 5/00

(52) U.S. Cl. 345/581

(57) ABSTRACT

There is provided an image rendering processing apparatus including: a deriving section that, based on range data representing an image rendering range for performing image rendering, derives an image rendering region for each image rendering line configured by a plurality of pixels configuring an image; a determination section that, for each pixel in each of the image rendering lines, determines the density of the pixel according to the ratio of the image rendering region relative to the pixel region and according to the density of the image rendering region.

### CROSS-REFERENCE TO RELATED APPLICATIONS

This application is based on and claims priority under 35 U.S.C. §119 from Japanese Patent Application No. 2008-309037 filed on Dec. 3, 2008, the disclosure of which is incorporated by reference herein.

### RELATED ART

1. Field of the Disclosure

The disclosure relates to an image rendering processing apparatus, and relates in particular to an image rendering processing apparatus that performs image rendering computation processing of an image processing LSI (Large-Scale Integration) or the like.

2. Description of the Related Art

Generally, an image processing LSI includes an image rendering computation circuit for performing image rendering of straight lines and rectangular shapes. Within such image processing LSI's there are types that do not have frame memory for storing the whole rendering image, have a line buffer with storage capability for only of several lines worth of image data, and perform image rendering one line at a time using data stored in the line buffer. Since such types of image processing LSI cannot hold one frames worth of the whole rendering image, they compute the slope of an image rendering line segment for each of the image rendering lines in an image rendering computation circuit. In addition they compute for the lines the image rendering pixel range of the image rendering line segment, outputting the computation result to an image rendering processing circuit.

For example, when the image to be rendered has an image rendering line segment of a specific width, a user uses input keys and a pointing device to designate on an operation screen the start point, the end point and the line width of an image rendering line segment for display on a screen. In the image processing LSI, the X coordinates and the Y coordinates of the start point and end point of the line segment designated for image rendering on the operation screen, the line width of the line segment and the like are input as image rendering parameters (range data representing the image rendering range for performing image rendering).

The image rendering computation circuit derives the slope of the line segment from the X coordinates and Y coordinates of the start point and end point of the line segment for image rendering input as image rendering parameters, computes the image rendering range based on the line width data of the input line segment for image rendering, and by such computation calculates the start point and the end point of image rendering pixels of the line segment for each of the image rendering lines. In the image processing LSI, image rendering of straight lines and rectangular shapes is performed by image rendering processing at a later stage, based on the start points and the end points of the image rendering pixels of the line segment calculated by the image rendering computation circuit.

An example of a straight line of given line width is shown in FIG. 8.

In the image processing LSI, for example, when a start point X coordinate strx, a start point Y coordinate stry, an end point X coordinate endx, an end point Y coordinate endy, and a line width lwidth have been input as image rendering parameters, image rendering is performed of a straight line having a given line width by changing input color data for pixels surrounded by the following four line segments: a set line segment that is a straight line connecting the start point and the end point; a parallel line segment that is a straight line parallel to the set line segment and passing through a pixel positioned at a line widths worth from a start point (FIG. 8 is an example having a line width in the Y coordinate direction. There are also cases having a line width in the X coordinate direction depending on the slope of the set line segment); an orthogonal line segment X min that is a straight line passing through the start point and intersecting orthogonally with the set line segment; and an orthogonal line segment X max that is a straight line passing through the end point and intersecting orthogonally with the set line segment.

Specifically, as shown in FIG. 17A and FIG. 17B, on a given image rendering line, the image rendering start point and the image rendering end point are calculated for each of the above four line segments, and the image rendering range is determined by comparison of the magnitude of the coordinates of these points.

In the image processing LSI, image rendering like that shown in FIG. 18 is carried out by repeatedly calculating the image rendering start point and the image rendering end point of each of the four line segments for each of the image rendering lines, and performing magnitude comparisons thereon.

However, as shown in FIG. 18, a problem arises in that the boundary of the straight line is formed in a ragged (jagged) stepped shape.

In order to address this issue a technique for making such jaggedness not so noticeable is described in Japanese Patent Application Laid-Open (JP-A) No. 2001-5989. This is accomplished by performing anti-aliasing processing in an image processing device applied to computer graphics technology, such as in game devices.

However, the anti-aliasing processing that is generally used computer graphics and the like, such as that of JP-A No. 2001-5989, requires complex computation, and when applied unmodified to image processing LSI, problems arise in that the circuit scale increases and the image rendering speed decreases.

### INTRODUCTION TO THE INVENTION

The present disclosure is made in consideration of the above issues, and an objective thereof is to provide an image rendering processing apparatus that can make jaggedness less noticeable, while suppressing any increase in circuit scale and any decrease in image rendering speed.

In order to achieve the above objective, a first aspect of the present disclosure provides an image rendering processing apparatus including:

a deriving section that, based on range data representing an image rendering range for performing image rendering, derives an image rendering region for each image rendering line configured by a plurality of pixels configuring an image; and,
a determination section that, for each pixel in each of the image rendering lines, determines the density of the pixel according to the ratio of the image rendering region relative to the pixel region and according to the density of the image rendering region.

According to the first aspect of the present disclosure, since an image rendering region is derived for each image rendering line configured by plural pixels configuring an image, based on the range data representing an image rendering range for performing image rendering, any increase in circuit scale and any decrease in image rendering speed can be suppressed. In addition, according to the first aspect of the present disclosure since, for each pixel in each of the image rendering lines, the density of the pixel is determined according to the ratio of the image rendering region relative to the pixel region and according to the density of the image rendering region, any jaggedness can be made less noticeable.

A second aspect of the present disclosure provides the image rendering processing apparatus of the first aspect, wherein when the density of the image rendering region is high the determination section raises the density as the ratio gets the higher, and when the density of the image rendering region is low the determination section lowers the density as the ratio gets higher.

A third aspect of the present disclosure provides the image rendering processing apparatus of the first aspect, wherein:

when the image to be rendered is an image rendering line segment of a specific width, the range data includes a start point and an end point of a line segments representing an edge of the outer boundary of the image rendering line segment, and a line width with respect to the edge; and

the deriving section derives a set line segment passing through the start point and the end point, a parallel line segment that is parallel to the set line segment and is positioned by the line width from the start point, a first orthogonal line segment that passes through the start point and intersects orthogonally with the set line segment, and a second orthogonal line segment that passes through the end point and intersects orthogonally with the set line segment, and for each image rendering line derives, as an image rendering region, a rectangular region surrounded by the set line segment, the parallel line segment, the first orthogonal line segment and the second orthogonal line segment.

A fourth aspect of the present disclosure provides the image rendering processing apparatus of the third aspect, wherein the determination section only performs computation to determine the density of the pixel, according to the ratio occupied of the image rendering region relative to the pixel region and according to the density of the image rendering region, for the pixels through which one or other of the sides of the rectangular region pass.

A fifth aspect of the present disclosure provides the image rendering processing apparatus of the fourth aspect, wherein, for pixels through which one or other of the sides of the rectangular region pass, the determination section changes a computation formula for determining the density of the pixels according to the angle of the side that passes through the pixel relative to the image rendering line.

As explained above, according to the present disclosure there is the superior effect in that jaggedness can be made less noticeable, while suppressing any increase in circuit scale and any decrease in image rendering speed.

### BRIEF DESCRIPTION OF THE DRAWINGS

Exemplary embodiments of the present disclosure will be described in detail based on the following figures, wherein:

FIG. 1 is a block diagram showing a schematic configuration of an image rendering computation circuit according to an exemplary embodiment;

FIG. 2 is a block diagram showing a detailed configuration of a slope computation section according to an exemplary embodiment;

FIG. 3 is a block diagram showing a detailed configuration of a base point computation section according to an exemplary embodiment;

FIG. 4 is a block diagram showing a detailed configuration of a selection section according to an exemplary embodiment;

FIG. 5 is a block diagram showing a detailed configuration of a memory section according to an exemplary embodiment;

FIG. 6 is a block diagram showing a detailed configuration of an addition section according to an exemplary embodiment;

FIG. 7 is a block diagram showing a detailed configuration of an image rendering computation circuit according to an exemplary embodiment;

FIG. 8 is a diagram showing an example of a line segment for image rendering according to an exemplary embodiment;

FIG. 9 is a flow chart showing a sequence when operating an image rendering computation circuit according to an exemplary embodiment in a line buffer mode;

FIG. 10 is a diagram showing an example of positions of each start point according to an exemplary embodiment;

FIG. 11 is a diagram showing an example in which anti-aliasing processing has been performed according to an exemplary embodiment;

FIG. 12 is a diagram showing an example of status determination according to an exemplary embodiment;

FIG. 13 is diagram in which pixels for image rendering an image rendering line according to an exemplary embodiment have been extracted;

FIG. 14A and FIG. 14B are explanatory diagrams for explaining a ratio computation according to an exemplary embodiment;

FIG. 15 is a block diagram showing a schematic configuration of an image rendering computation circuit according to another exemplary embodiment;

FIG. 16 is a flow chart showing a sequence when operating an image rendering computation circuit according to another exemplary embodiment in a frame memory mode;

FIG. 17A and FIG. 17B are explanatory diagrams for explaining prior art image rendering computation; and

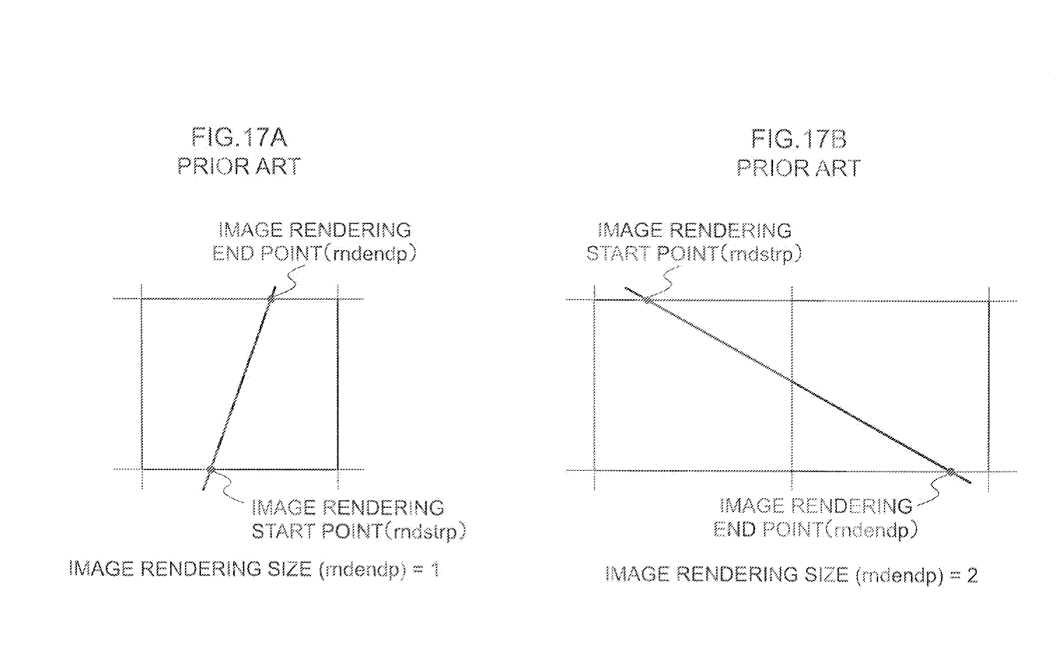

FIG. 18 is a diagram showing an example of an image rendering result according to prior art image rendering computation.

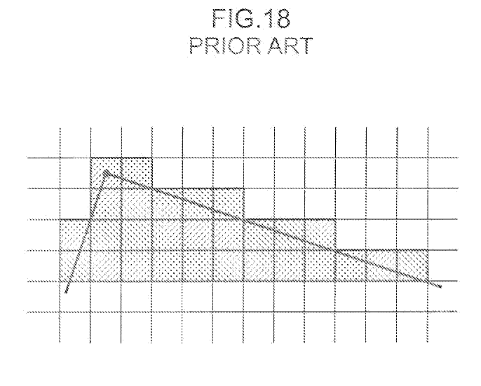

### DETAILED DESCRIPTION

The exemplary embodiments of the present disclosure are described and illustrated below to encompass an image rendering processing apparatus, and relates in particular to an image rendering processing apparatus that performs image rendering computation processing of an image processing LSI or the like. Of course, it will be apparent to those of ordinary skill in the art that the preferred embodiments discussed below are exemplary in nature and may be reconfigured without departing from the scope and spirit of the present disclosure. However, for clarity and precision, the exemplary embodiments as discussed below may include optional steps, methods, and features that one of ordinary skill should recognize as not being a requisite to fall within the scope of the present disclosure. Hereinafter, an exemplary embodiment of the present disclosure will be described in detail with reference to the drawings.

Explanation will now be given of details regarding an exemplary embodiment of the present disclosure, with reference to the drawings. Note that explanation will be given below of a case in which application of the present disclosure is made to an image processing LSI for image rendering a line segment of a given width.

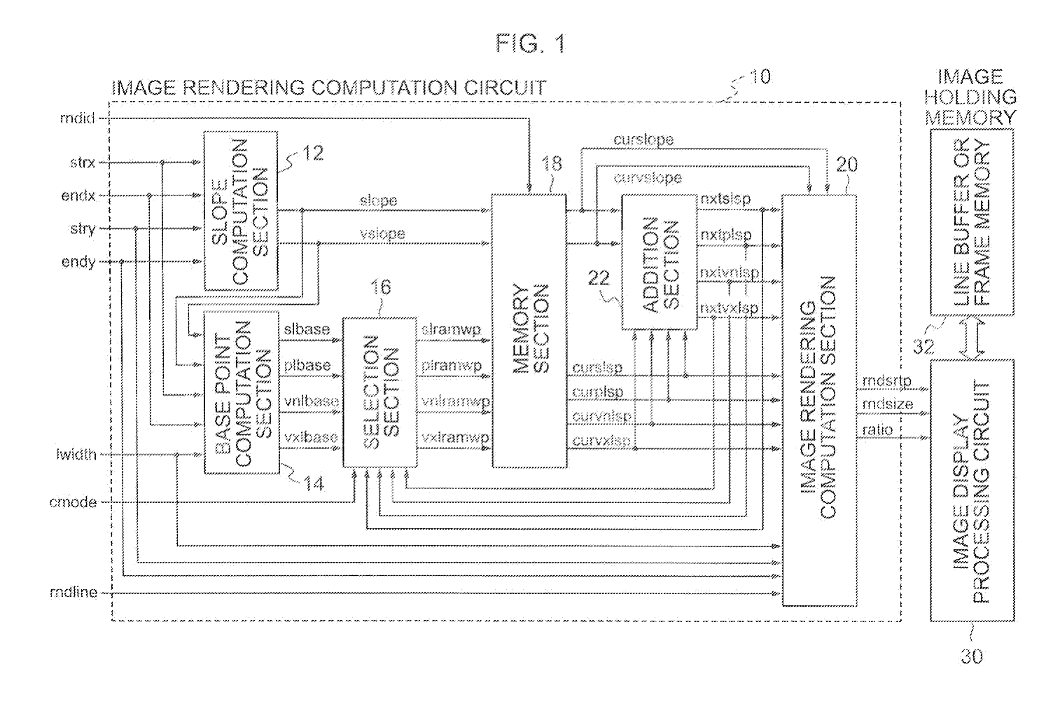

FIG. 1A shows a block diagram depicting each configuration element of an image rendering computation circuit 10 included in an image processing LSI according to the present exemplary embodiment. Note that portions not directly related to the present disclosure are omitted from the drawings and not explained.

The image rendering computation circuit 10 includes a slope computation section 12, a base point computation section 14, a selection section 16, a memory section 18, an image rendering computation section 20, and an addition section 22.

The slope computation section 12 has the function of computing the slope of a line segment to be image rendered. A start point X coordinate strx, an end point X coordinate endx, a start point Y coordinate stry, and an end point Y coordinate endy are input, for example, through a pointing device, to the slope computation section 12 as image rendering parameters of a line segment to be image rendered.

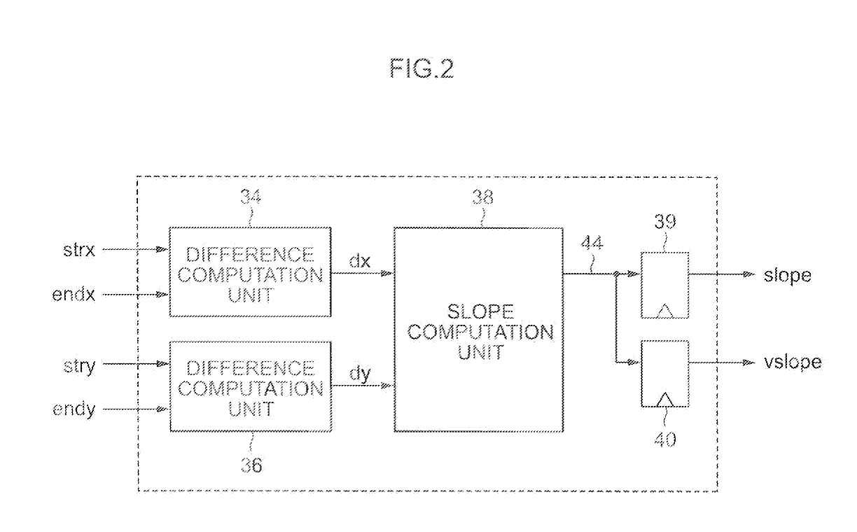

The slope computation section 12, as shown in FIG. 2, includes difference computation units 34 and 36, a slope computation unit 38, and registers 39 and 40. The start point X coordinate strx and the end point X coordinate endx are supplied to the difference computation unit 34. The start point Y coordinate stry and the end point Y coordinate endy are supplied to the difference computation unit 36.

The difference computation unit 34 calculates a difference dx in the X direction by computing a difference (endx−strx) based on the supplied start point X coordinate strx and end point X coordinate endx, and supplies the calculated X direction difference dx to the slope computation unit 38.

The difference computation unit 36 calculates a difference dy in the Y direction by computing a difference (endy−stry) based on the supplied start point Y coordinate stry and end point Y coordinate endy, and supplies the calculated Y direction difference dy to the slope computation unit 38.

The slope computation unit 38, performs computation split into two times, by time division, of the slope of a set line segment and an orthogonal line segment. The slope computation unit 38 first uses the supplied X direction difference dx and Y direction difference dy, and calculates the slope data (dx/dy) that is the incremental in the X coordinate for one scan line, and outputs the calculated slope data as slope data slope. The slope computation unit 38 then calculates orthogonal slope data that is orthogonal to the slope data (dx/dy) by performing computation of −1/(dx/dy), and outputs the computed orthogonal slope data as slope data vslope.

The registers 39 and 40 are connected to the output side of the slope computation unit 38, the slope data slope is stored in the register 39, and the slope data vslope is stored in the register 40. The slope data slope and the slope data vslope stored in the respective registers 39 and 40 are output to the base point computation section 14 and the memory section 18.

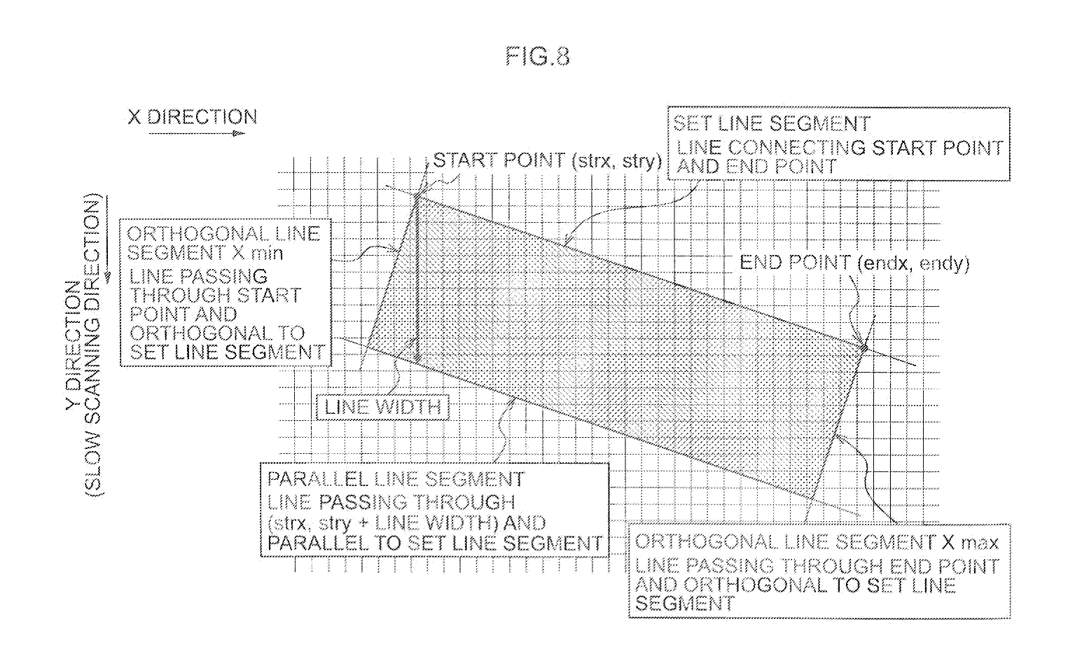

In FIG. 8, the slope data slope represents the slope of the set line segment and of a parallel line segment, and the slope data vslope represents the slope of an orthogonal line segment X min and an orthogonal line segment X max, where: the set line segment is a straight line connecting the start point and the end point of a line segment to be image rendered; the parallel line segment is a straight line parallel to the set line segment and passing through a pixel positioned at a line widths worth from the start point; the orthogonal line segment X min is a straight line passing through the start point and intersecting orthogonally with the set line segment; and the orthogonal line segment X max is a straight line passing through the end point and intersecting orthogonally with the set line segment.

When the sign of the slope data slope and the slope data vslope is “+” then this represents a line segment that slopes down to the right, and when the sign is “−” then this represents a line segment that slopes down to the left.

Note that in the slope computation unit 38 according to the present exemplary embodiment, when the difference dx is “0”, the line segment is vertical and the slope data slope is set at “0”. In a similar manner, when the difference dy is “0”, the line segment is horizontal, and the slope data slope is also set at “0”. When rendering one or other of a parallel line segment, an orthogonal line or a rectangular shape, if the slope of the set line segment is “0” then the orthogonal computation section 39 also makes the slope of the orthogonal line segment “0”, the same as the set line segment.

Returning to FIG. 1, when image rendering one frames worth of an image by scanning one line at a time, the base point computation section 14 has the function of calculating the base points where the set line segment, the parallel line segment, the orthogonal line segment X min and the orthogonal line segment X max first intersect with the image rendering line being scanned. Note that, for convenience, these base points will be referred to below as either start points or end points according to their positional relationship to the image rendering line for image rendering.

The start point X coordinate strx, the end point X coordinate endx, the line width lwidth, the slope data slope and the slope data vslope are supplied to the base point computation section 14.

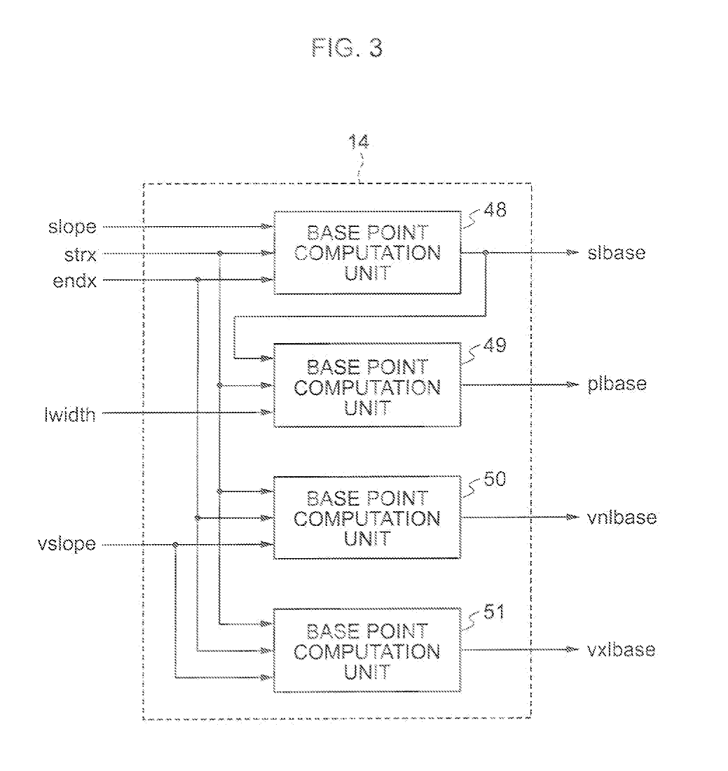

The base point computation section 14, as shown in FIG. 3, includes base point computation units 48, 49, 50 and 51.

The start point X coordinate strx, the end point X coordinate endx and the slope data slope are input to the base point computation unit 48. The start point X coordinate strx, the line width lwidth and the output of the base point computation unit 48, this being an image rendering base point slbase of the set line segment, are input to the base point computation unit 49. The start point X coordinate strx, the end point X coordinate endx and the slope data vslope are input to the base point computation unit 50. The start point X coordinate strx, the end point X coordinate endx and the slope data vslope are input to the base point computation unit 51.

The base point computation unit 48 derives the position the set line segment intersects with the image rendering line, as the image rendering base point slbase of the set line segment. When the sign of the supplied slope data slope is “+”, a value of the smaller coordinate of the start point X coordinate strx and the end point X coordinate endx from which is subtracted half of the slope data slope is set as the image rendering base point slbase of the set line segment. When the sign of the supplied slope data slope is “−”, a value of the larger coordinate of the start point X coordinate strx and the end point X coordinate endx from which is subtracted half of the slope data slope is set as the image rendering base point slbase of the set line segment. The set image rendering base point slbase of the set line segment is output to the selection section 16.

The base point computation unit 49 derives the position at which the parallel line segment intersects with the image rendering line, as an image rendering base point plbase of the parallel line segment. When the absolute value of the slope represented by slope data slope is greater than 1 (θ<45°), a value of the image rendering base point slbase of the set line segment from which is subtracted the slope data slope×(line width−1) is set at the image rendering base point plbase of the parallel line segment. When the absolute value of the slope is 1 or less (θ=0, θ≧45°) then a value of the image rendering base point slbase of the set line segment to which is added (line width −1) is set as the image rendering base point plbase of the parallel line segment, and the set image rendering base point plbase of the parallel line segment is output to the selection section 16.

In the present exemplary embodiment here, the line width direction changes at a boundary θ=45°, with the Y direction as the width direction when the absolute value of the slope represented by the slope data slope is greater than 1, and the X direction as the width direction when the absolute value of the slope represented by the slope data slope is 1 or less. Therefore, the base point computation unit 49 changes computation of the image rendering base point of the parallel line segment at a boundary of θ=45°.

The base point computation unit 50 derives, as an image rendering base point vnlbase of the orthogonal line segment X min, the position the orthogonal line segment X min intersects with the image rendering line. When the sign of the supplied slope data vslope is “+”, a value of the smaller coordinate of the start point X coordinate strx and the end point X coordinate endx from which is subtracted half of the slope data vslope is set as the image rendering base point vnlbase of the orthogonal line segment X min. When the sign of the supplied slope data vslope is “−”, a value of the larger coordinate of the start point X coordinate strx and the end point X coordinate endx from which is subtracted half of the slope data vslope is set as the image rendering base point vnlbase of the orthogonal line segment X min. The set image rendering base point vnlbase of the orthogonal line segment X min is output to the selection section 16.

The base point computation unit 51 derives, as an image rendering base point vxlbase of the orthogonal line segment X max, the position the orthogonal line segment X max intersects with the image rendering line. When the sign of the supplied slope data vslope is “+”, a value of the larger coordinate of the start point X coordinate strx and the end point X coordinate endx from which is subtracted half of the slope data vslope is set as the image rendering base point vxlbase of the orthogonal line segment X max. When the sign of the supplied slope data vslope is “−”, a value of the smaller coordinate of the start point X coordinate strx and the end point X coordinate endx from which is subtracted half of the slope data vslope is set as the image rendering base point vxlbase of the orthogonal line segment X max. The set image rendering base point vxlbase of the orthogonal line segment X max is output to the selection section 16.

Returning to FIG. 1, the selection section 16 has the function of selecting the base point for use when image rendering. The selection section 16 is supplied, output from the base point computation section 14, with the image rendering base point slbase of the set line segment of the first image rendering line for scanning, the image rendering base point plbase of the parallel line segment thereof, the image rendering base point vnlbase of the orthogonal line segment X min thereof, and the image rendering base point vxlbase of the orthogonal line segment X max thereof. The selection section 16 is also supplied with a computation mode cmode, and an image rendering base point nxtslsp of the set line segment for the next image rendering line, an image rendering base point nxtplsp of the parallel line segment therefor, an image rendering base point nxtvnlsp of the orthogonal line segment X min therefor and an image rendering base point nxtvxlsp of the orthogonal line segment X max therefor, these being output from the addition section 22.

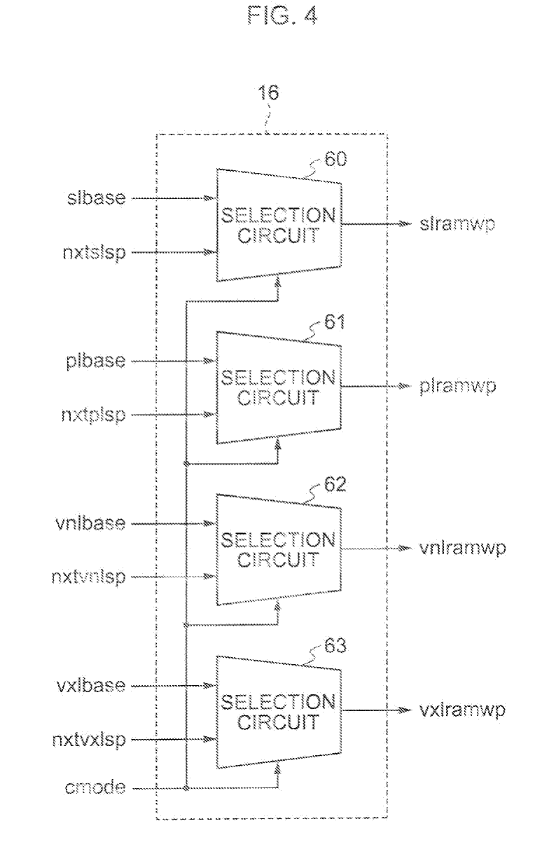

The selection section 16, as shown in FIG. 4, includes selection circuits 60, 61, 62 and 63. The image rendering base point slbase and the image rendering base point nxtslsp of the set line segments are supplied to the selection circuit 60. The image rendering base point plbase and the image rendering base point nxtplsp of the parallel line segments are supplied to the selection circuit 61. The image rendering base point vnlbase and the image rendering base point nxtvnlsp of the orthogonal line segments X min are supplied to the selection circuit 62. The image rendering base point vxlbase and the image rendering base point nxtvxlsp of the orthogonal line segments X max are supplied to the selection circuit 63. In addition the computation mode anode representing slope computing or image rendering computing is supplied to the selection circuits 60, 61, 62 and 63. This computation mode cmode has a slope computation mode and an image rendering computation mode.

The selection circuit 60 selects one or other of the image rendering base point slbase or the image rendering base point nxtvxlsp according to the computation mode cmode supplied. When the computation mode cmode is the slope computation mode, the image rendering base point slbase is output as a start point slramwp of the set line segment to the memory section 18. When the computation mode cmode is the image rendering computation mode the image rendering base point nxtvxlsp is output as the start point slramwp to the memory section 18.

The selection section 61 selects one or other of the image rendering base point plbase or the image rendering base point nxtplsp according to the computation mode cmode. When the computation mode cmode is the slope computation mode the image rendering base point plbase is output as a start point plramwp of the parallel line segment to the memory section 18. When the computation mode cmode is the image rendering computation mode the image rendering base point nxtplsp is output as the start point plramwp of the parallel line segment to the memory section 18.

The selection circuit 62 selects one or other of the image rendering base point vnlbase or the image rendering base point nxtvnlsp according to the computation mode cmode. When the computation mode cmode is the slope computation mode, the image rendering base point vnlbase is output as a start point vnlramwp of the orthogonal line segment X min to the memory section 18. When the computation mode cmode is the image rendering computation mode, the image rendering base point nxtvnlsp is output as the start point vnlramwp of the orthogonal line segment X min to the memory section 18.

The selection circuit 63 selects one or other of the image rendering base point vxlbase or the image rendering base point nxtvxlsp according to the computation mode cmode. When the computation mode cmode is the slope computation mode, the image rendering base point vxlbase is output as a start point vxlramwp of the orthogonal line segment X max to the memory section 18. When the computation mode cmode is the image rendering computation mode the image rendering base point nxtvxlsp is output as the start point vxlramwp of the orthogonal line segment X max to the memory section 18.

Returning to FIG. 1, in the memory section 18 an image rendering identification number rndid is supplied as an address of the memory section 18 to the memory section 18. In the image processing LSI according to the present exemplary embodiment, image rendering of plural lines of image rendering line segments can be performed, and the image rendering identification number rndid is data representing the sequence number of the line segment.

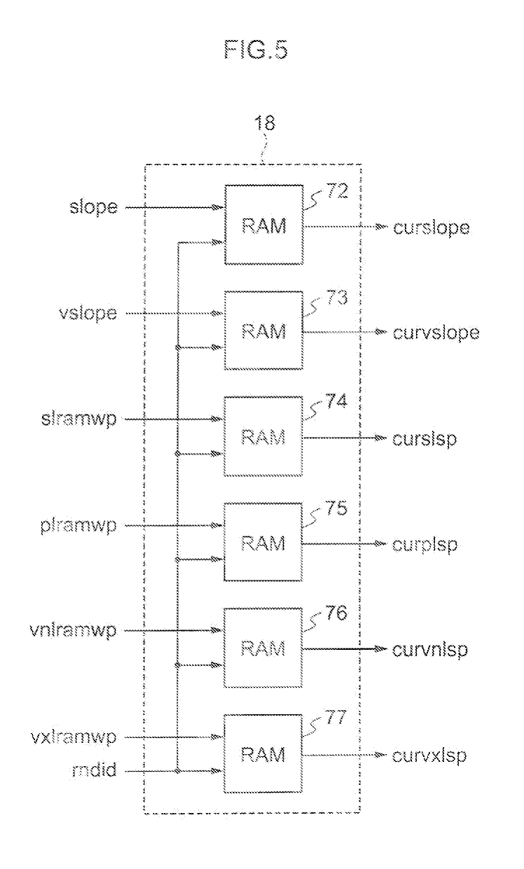

The memory section 18, as shown in FIG. 5, includes 6 RAM's (Random Access Memories) 72, 73, 74, 75, 76, and 77. The slope data slope is supplied to the RAM 72, the slope data vslope is supplied to the RAM 73. The start point slramwp of the set line segment is supplied to the RAM 74, the start point plramwp of the parallel line segment is supplied to the RAM 75, the start point vnlramwp of the orthogonal line segment X min is supplied to the RAM 76, and the start point vxlramwp of the orthogonal line segment X max is supplied to the RAM 77. The image rendering identification number rndid is also supplied as an address to each of the respective RAM's 72, 73, 74, 75, 76, and 77.

The RAM's 72, 73, 74, 75, 76, and 77 each store the start point data supplied thereto at the address designated by the image rendering identification number rndid. The RAM's 72, 73, 74, 75, 76, and 77 are also configured capable of reading out and outputting data that has been stored at an address designated by the image rendering identification number rndid.

The RAM's 72, 73, 74, 75, 76, and 77 respectively output data curslope, data curvslope, data curslsp, data curplsp, data curvnlsp and data curvxlsp, as the start points of the image rendering line subject to processing, from the address designated by the image rendering identification number rndid to the image rendering computation section 20 and the addition section 22.

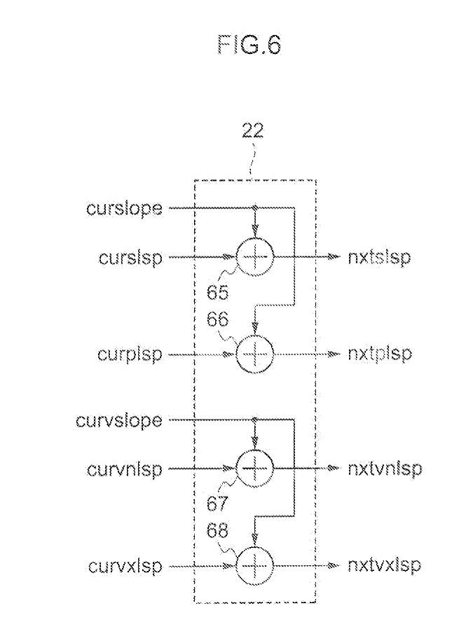

Returning to FIG. 1, the addition section 22 has the function of calculating the base point where the next image rendering line intersects respectively with the set line segment, the parallel line segment, the orthogonal line segment X min and the orthogonal line segment X max. The addition section 22, as shown in FIG. 6, includes four adding units 65, 66, 67 and 68.

The data curslope and the data curslsp are supplied to the adding unit 65. The data curslope and the data curplsp are supplied to the adding unit 66. The data curvslope and the data curvnlsp are supplied to the adding unit 67. The data curslope and the data curvxlsp are supplied to the adding unit 68.

The adding unit 65 adds together the supplied data curslope and the data curslsp, and outputs the summed data nxtslsp to the selection section 16 and the image rendering computation section 20. The adding unit 66 adds together the supplied data curslope and the data curplsp and outputs the summed data nxtplsp to the selection section 16 and the image rendering computation section 20. The adding unit 67 adds together the supplied data curvslope and data curvnlsp, and outputs the summed data nxtvnlsp to the selection section 16 and the image rendering computation section 20. The adding unit 68 adds together the supplied data curvslope and the data curvxlsp and outputs the summed data nxtvxlsp to the selection section 16 and the image rendering computation section 20.

The data nxtslsp, the data nxtplsp, the data nxtvnlsp and the data nxtvxlsp are respectively the start points of the set line segment, the parallel line segment, the orthogonal line segment X min and the orthogonal line segment X max of the next line of the image rendering line, and are also respectively the end points of the set line segment, the parallel line segment, the orthogonal line segment X min and the orthogonal line segment X max of the image rendering line subject to processing.

The image rendering computation section 20 is input with: the respective start points of the set line segment, the parallel line segment, the orthogonal line segment X min and the orthogonal line segment X max of the image rendering line subject to processing (curslsp, curplsp, curvnlsp, curvxlsp); the respective start points of the set line segment, the parallel line segment, the orthogonal line segment X min and the orthogonal line segment X max of the next image rendering line (nxtslsp, nxtplsp, nxtvnlsp, nxtvxlsp); the slope of the set line segment and the parallel line segment, data curslope; the slope of the orthogonal line segment X min and the orthogonal line segment X max, data curvslope; the line width lwidth; the start point Y coordinate stry; and the end point Y coordinate endy.

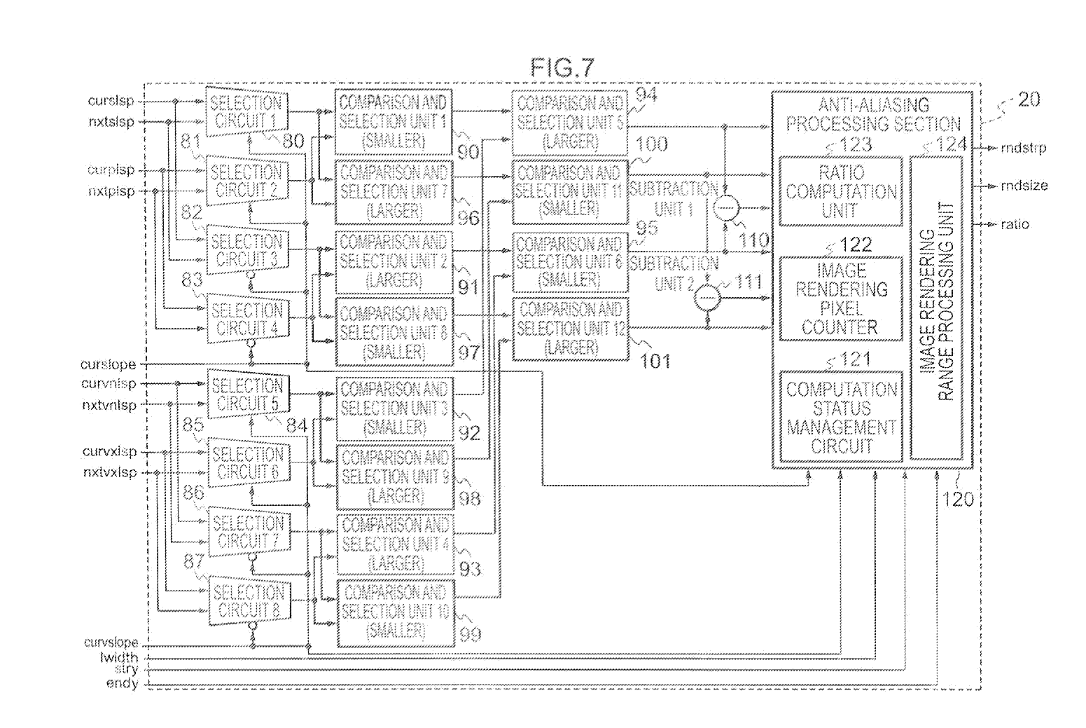

The image rendering computation section 20 according to the present exemplary embodiment, as shown in FIG. 7, includes eight individual selection circuits 80 to 87, twelve individual comparison and selection units 90 to 101, two individual subtraction units 110 and 111, and an anti-aliasing processing section 120.

The start points curslsp and nxtslsp of the set line segment are connected to the selection circuit 80 and the selection circuit 82. The selection circuit 80 is connected to a sign bit of the slope data curslope of the set line segment and the parallel line segment, and the selection circuit 82 is connected to an inverse signal of the sign bit of the slope data curslope.

The start points curplsp and nxtslsp of the parallel line segment are connected to the selection circuit 81 and the selection circuit 83. The selection circuit 81 is connected to the sign bit of the slope data curslope of the set line segment and the parallel line segment, and the selection circuit 83 is connected to an inverse signal of the sign bit of the slope data curslope.

The start points curvnlsp and nxtvnlsp of the orthogonal line segment X min are connected to the selection circuit 84 and the selection circuit 86. The selection circuit 84 is connected to the sign bit of the slope data curvslope of the orthogonal line segment X min and the orthogonal line segment X max, and the selection circuit 86 is connected to an inverse signal of the sign bit of the slope data curvslope.

The start points curvxlsp and nxtvxlsp of the orthogonal line segment X max are connected to the selection circuit 85 and the selection circuit 87. The selection circuit 85 is connected to the sign bit of the slope data curvslope of the orthogonal line segment X min and the orthogonal line segment X max, and the selection circuit 87 is connected to an inverse signal of the sign bit of the slope data curvslope.

The comparison and selection unit 90 and the comparison and selection unit 92 are connected to the comparison and selection unit 94. The comparison and selection unit 91 and the comparison and selection unit 93 are connected to the comparison and selection unit 95, the comparison and selection unit 96 and the comparison and selection unit 98 are connected to the comparison and selection unit 100, and the comparison and selection unit 97 and the comparison and selection unit 99 are connected to the comparison and selection unit 101.

The comparison and selection unit 94 and the comparison and selection unit 95 are connected to the subtraction unit 110, the comparison and selection unit 100 and the comparison and selection unit 101 are connected to the subtraction unit 111. The subtraction unit 110 and the subtraction unit 111 are connected to the anti-aliasing processing section 120. The slope data curslope of the set line segment and the parallel line segment, the slope data curvslope of the orthogonal line segment X min and orthogonal line segment X max, the line width lwidth, the start point Y coordinate stry, and the end point Y coordinate endy are also connected to the anti-aliasing processing section 120, and the anti-aliasing processing section 120 outputs a rndstrp signal, a rndsize signal, and a ratio signal to an image display processing circuit 30.

The image display processing circuit 30 performs image rendering based on the input rndstrp signal, rndsize signal, and ratio signal.

A simple description will now be given regarding the operation of the image rendering computation circuit 10 applied to an image rendering processing apparatus according to the present exemplary embodiment.

The image rendering computation circuit 10 in the line buffer mode features computation that is broadly divided into two parts. The first part of the computation is a slope computation mode that, as pre-preparation for image rendering, derives the slope and base point of each command by slope computation and stores these in the memory section 18. This is by way of executing slope computation each time the display frame changes so as to be performed during V (vertical) blanking intervals of a display device such as, for example, an LCD (Liquid Crystal Display) panel. The other part of the image rendering computation in the image rendering computational circuit 10 is an image rendering computation mode of image rendering computation during actual image rendering of a straight line or rectangular shape. This image rendering computation derives an image rendering pixel range of each of the commands for a given line, and outputs these to a later stage image rendering processing section.

When image rendering is performed of an image of a single frame, a computation mode cmode during V (vertical) blanking intervals of the display device is set to the slope computation mode, and the image rendering parameters of the line segment to be image rendered and the image rendering identification number rndid of this line segment are input in sequence to the image rendering computation circuit 10.

When the pre-preparation, this being the slope computation, has been completed, the computation mode cmode of the image rendering computation circuit 10 is set to image rendering computation mode.

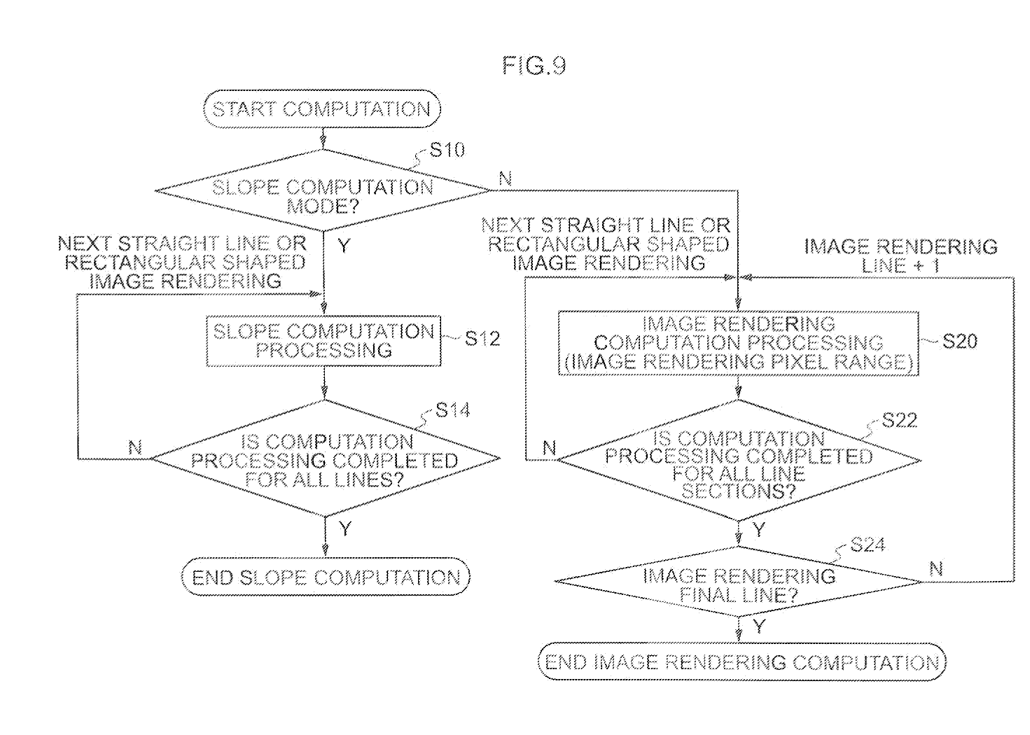

In the image rendering computation circuit 10 according to the present exemplary embodiment, as shown in FIG. 9, determination is made as to whether or not the computation mode is the slope computation mode (step S10). When the computation mode is the slope computation mode (YES) the routine proceeds to slope computation processing. However, when the computation mode is not the computation mode (NO) the routine proceeds to image rendering computation processing.

In slope computation processing (step S12), the slope and base point of the line segment to be image rendered are derived, stored in the memory section 18, and by determining whether or not all line segment computation has been completed (step S14), the slope computation processing is repeated a number of times that is the number of the line segments to be image rendered.

In this slope computation processing, the slope computation section 12 computes the slope of the line segment for each of the input image rendering parameters.

Specifically, the difference dx of the X coordinates is derived from the start point X coordinate strx and the end point X coordinate endx in the difference computation unit 34, the difference dy of the Y coordinates is derived from the start point Y coordinate stry and the end point Y coordinate endy in the difference computation unit 36. The slope data slope of the set line segment and the parallel line segment is then derived in the slope computation unit 38 by calculating (dx/dy), and the slope data vslope of the orthogonal line segment X min and the orthogonal line segment X max is derived in the orthogonal computation section 39 by performing computation of −1/(dx/dy).

The slope data slope and the slope data vslope here are the slope of the increment of X coordinates for one line. Note that when the difference dx of the X coordinates is “0”, the line segment is a vertical line and the slope data slope is also set to “0”. In a similar manner, when the difference dy is “0” then the line segment is a horizontal line and the slope data slope is also set to “0”. The slope data slope that has been derived is written to the RAM 72 with the image rendering identification number rndid as the address, and the slope data vslope is written to the RAM 73 with the image rendering identification number rndid as the address.

The base point computation section 14 derives, for each of the image rendering parameters input, the base point where each of the set line segment, the parallel line segment, the orthogonal line segment X min and the orthogonal line segment X max first intersect with image rendering line being scanned, and stores the derived base points in the memory section 18.

Specifically, the image rendering base point slbase of the set line segment is derived in the base point computation unit 48, the image rendering base point plbase of the parallel line segment is derived in the base point computation unit 49, the image rendering base point vxlbase of the orthogonal line segment X min is derived in the base point computation unit 50, and the image rendering base point vxlbase of the orthogonal line segment X max is derived in the base point computation unit 51. The base point computation section 14 outputs to the selection section 16 the derived image rendering base point slbase of the set line segment, the image rendering base point plbase of the parallel line segment, the image rendering base point vxlbase of the orthogonal line segment X min and the image rendering base point vxlbase of the orthogonal line segment X max.

When the computation mode cmode is the slope computation mode, the selection section 16 outputs each of the data output from the base point computation section 14 to the memory section 18, as the respective start points of each of the line segments. By so doing, the derived image rendering base point slbase of the set line segment is written to the RAM 74 with the image rendering identification number rndid as the address, the image rendering base point plbase of the parallel line segment is written to the RAM 75 with the image rendering identification number rndid as the address, the image rendering base point vnlbase of the orthogonal line segment X min is written to the RAM 76 with the image rendering identification number rndid as the address, and the image rendering base point vnlbase of the orthogonal line segment X min is written to the RAM 77 with the image rendering identification number rndid as the address.

The image rendering computation circuit 10 repeats processing, to save in the memory section 18 the derived slope and base points of the line segment to be image rendered, a number of times that is the number of the line segments to be image rendered.

When the pre-preparation, this being the slope computation, is completed, the computation mode cmode is set in the image rendering computation circuit 10 to the image rendering computation mode for performing image rendering computation processing.

When the computation mode cmode is set to the image rendering computation mode, in the image rendering computation circuit 10, image rendering lines rndline to be image rendered are input in sequence one line at a time, and while in a state in which each of the image rendering lines rndline have been input, the image rendering parameters of each of the line segments to be image rendered and the rendering identification numbers rndid of these line segments are also input in sequence.

Namely, image rendering parameters of each of the line segments to be image rendered are input in sequence against each of the image rendering lines to be image rendered, and in addition, when it is time for the next image rendering line, the image rendering parameters of each of the line segments to be image rendered are again input in sequence.

In the image rendering computation processing, image rendering computation is performed that computes an image rendering pixel range of the line segments to be image rendered against each of the image rendering lines, in sequence one line at a time (step S20 in FIG. 9), and by determining whether or not image rendering computation has been completed for all of the line segments (step S22), the image rendering computation is repeated a number of times that is the number of the line segments to be image rendered. All of the image rendering lines are image rendered by completing image rendering computation processing for each of the image rendering lines and determining whether or not the current line is the final line (step S24).

In this image rendering computation processing, the data curslope, the data curvslope, the data curslsp, the data curplsp, the data curvnlsp and the data curvxlsp that have been stored at the addresses designated by the rendering identification number rndid are read out from the RAM's 72, 73, 74, 75, 76, and 77, and output to the image rendering computation section 20 and the addition section 22.

The addition section 22 calculates the start points (nxtslsp, nxtplsp, nxtvnlsp, nxtvxlsp) for the set line segment, the parallel line segment, the orthogonal line segment X min and the orthogonal line segment X max of the next image rendering line based on the data curslope, the data curvslope, the data curslsp, the data curplsp, the data curvnlsp and the data curvxlsp supplied from the RAM's 72, 73, 74, 75, 76, and 77, and outputs these to the selection section 16 and the image rendering computation section 20.

Specifically, the adding unit 65 adds together the supplied data curslope and data curplsp, calculates the start point nxtslsp of the set line segment for the image rendering of the next line, the adding unit 66 adds together the supplied data curslope and data curplsp and calculates the start point nxtplsp of the parallel line segment for the image rendering of the next line, the adding unit 67 adds together the supplied data curvslope and data curvnlsp and calculates the start point nxtvnlsp of the orthogonal line segment X min for the image rendering of the next line, and the adding unit 68 acids together the supplied data curvslope and data curvxlsp and calculates the start point nxtvxlsp of the orthogonal line segment X max for the image rendering of the next line.

The respective start points (nxtslsp, nxtplsp, nxtvnlsp, nxtvxlsp) of the set line segment, the parallel line segment, the orthogonal line segment X min and the orthogonal line segment X max for the next image rendering line that have been computed are overwritten and stored in the RAM's 74 to 77 for computation of the next image rendering line.

In the image rendering computation section 20, the image rendering start points curslsp, curplsp, curvnlsp, and curvxlsp of the four line segments on the image rendering line subject to processing, and the image rendering start points nxtslsp, nxtplsp, nxtvnlsp, nxtvxlsp of the four line segments on the next image rendering line, are computed and input to the image rendering computation section 20.

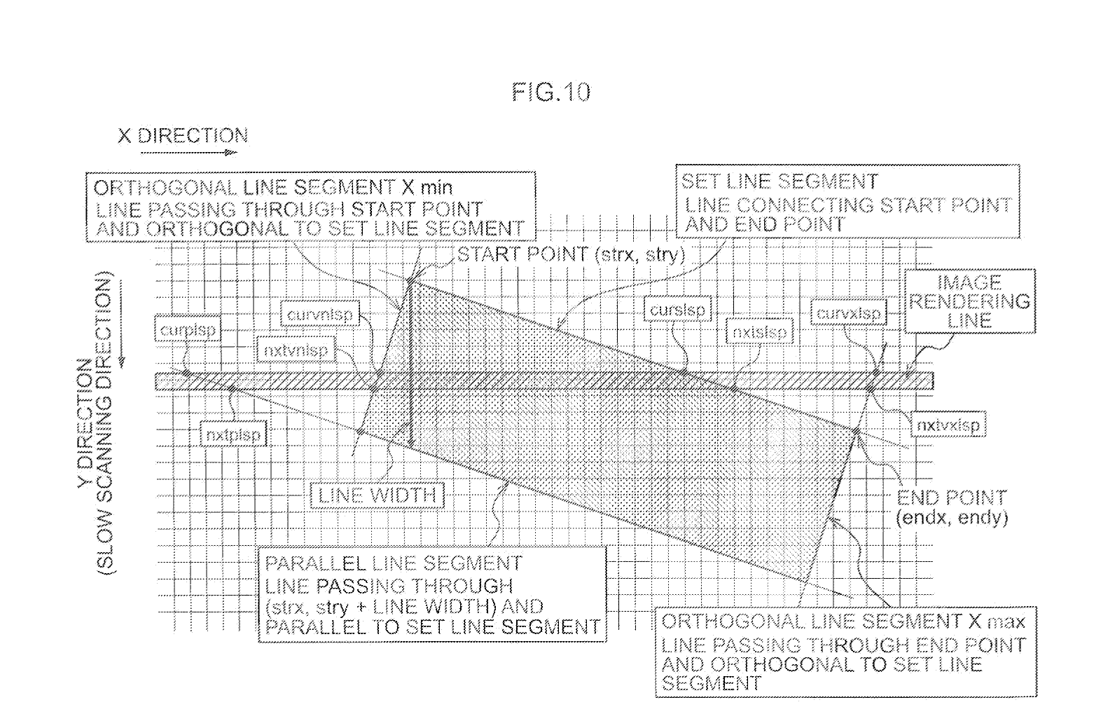

FIG. 10 shows an example of the positional relationships between the image rendering start point curslsp of the set line segment of the image rendering line subjected to processing, the image rendering start point curplsp of the parallel line segment thereof, the image rendering start point curvnlsp of the orthogonal line segment X min thereof, and the image rendering start point curvxlsp of the orthogonal line segment X max thereof, and the image rendering start point nxtslsp of the set line segment of the next image rendering line, the image rendering start point nxtplsp of the parallel line segment thereof, the image rendering start point nxtvnlsp of the orthogonal line segment X min thereof, and the image rendering start point nxtvxlsp of the orthogonal line segment X max.

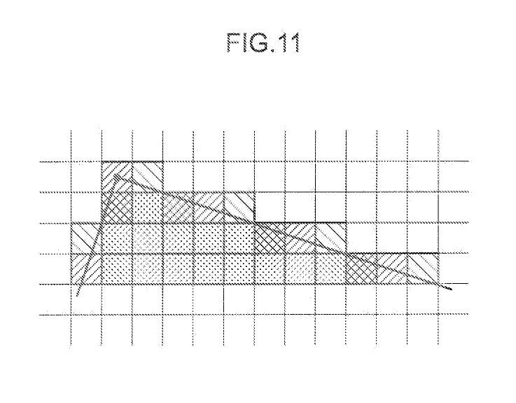

In the image rendering computation section 20, anti-aliasing processing is performed in the anti-aliasing processing section 120 so as to blur pixels at the edge of straight lines for image rendering, as shown in FIG. 11. In the pixels at straight lines for image rendering, the color that was going to be image rendered and the image rendered color can be realized by summing at given ratios.

For the pixels for which there is no need to perform anti-aliasing processing, the color that was going to be image rendered may simply be used as the new color data for these pixels. In the anti-aliasing processing section 120 according to the present exemplary embodiment, a ratio is computed one pixel at a time for the pixels to which anti-aliasing processing is to be performed, and this ratio is output together with the coordinate data thereof. This ratio is set at 100% for the pixels to which no anti-aliasing processing is to be performed, and the coordinate of the start pixel and the number of pixels to which no anti-aliasing processing is to be performed is output.

A more detailed explanation will now be given of such an operation in the image rendering computation section 20.

The selection circuit 80 selects the smaller of the image rendering start points curlslsp and the nxtslsp of the set line segments using the sign of the curslope and passes to the comparison and selection unit 90. When the sign of the curslope is “+(=0)” then the curslsp is selected, and when the sign is “−(=1)” then the nxtslsp is selected. The selection circuit 82, in contrast, selects data of the larger of the two image rendering start points of the set line segments and passes to the comparison and selection unit 91.

The data of each of the image rendering start points for the other three line segments are also selected in a similar manner using the sign of the slopes of each of the line segments, and passed to the comparison and selection units 92 to 93, and selection units 96 to 99. The following data are output from the selection circuits 80 to 87.

Selection circuit 80: the smaller value of the start point on the two image rendering lines of the set line segments.

Selection circuit 81: the smaller value of the start point on the two image rendering lines of the parallel line segments.

Selection circuit 82: the larger value of the start point on the two image rendering lines of the set line segments.

Selection circuit 83: the larger value of the start point on the two image rendering lines of the parallel line segments.

Selection circuit 84: the smaller value of the start point on the two image rendering lines of the orthogonal line segments X min.

Selection circuit 85: the smaller value of the start point on the two image rendering lines of the orthogonal line segments X max.

Selection circuit 86: the larger value of the start point on the two image rendering lines of the orthogonal line segments X max.

Selection circuit 87: the lager value of the start point on the two image rendering lines of the orthogonal line segments X min.

In the comparison and selection units 90, 92, 97 and 99, the smaller of the two input start point data are selected and passed to the comparison and selection units 94 or 101, and in the comparison and selection units 91, 93, 96 and 98 the larger of the two input specific data are selected and passed to the comparison and selection units 95 or 100. The following data is output from each of the comparison and selection units.

Comparison and selection unit 90: the smaller value of each of the image rendering start points of the set line segment and the parallel line segment.

Comparison and selection unit 91: the larger value of each of the image rendering start points of the set line segment and the parallel line segment.

Comparison and selection unit 92: the smaller value of each of the image rendering start points of the orthogonal line segment X min and the orthogonal line segment X max.

Comparison and selection unit 93: the larger value of each of the image rendering start points of the orthogonal line segment X min and the orthogonal line segment X max.

Comparison and selection unit 96: the smaller value of each of the image rendering start points of the set line segment and the parallel line segment.

Comparison and selection unit 97: the larger value of each of the image rendering start points of the set line segment and the parallel line segment.

Comparison and selection unit 98: the smaller value of each of the image rendering start points of the orthogonal line segment X min and the orthogonal line segment X max.

Comparison and selection unit 99: the larger value of each of the image rendering start points of the orthogonal line segment X min and the orthogonal line segment X max.

In the comparison and selection unit 94, the larger of the two input start point data is selected, and in the comparison and selection unit 95 the smaller of the two start point data is selected, and these are passed to the subtraction unit 110 and to the anti-aliasing processing section 120. Also, in the comparison and selection unit 100 the smaller of the two start point data is selected, in the comparison and selection unit 101 the larger of the two start point data is selected, and these are passed to the subtraction unit 111 and the anti-aliasing processing section 120. The following data are output as the outputs of each of the comparison and selection units and subtraction units.

Comparison and selection unit 94: overall image rendering start point.

Comparison and selection unit 95: overall image rendering start point.

Subtraction unit 110: overall image rendering size.

Comparison and selection unit 100: image rendering start point of where no anti-aliasing processing is to be performed.

Comparison and selection unit 101: image rendering end point of where no anti-aliasing processing is to be performed.

Subtraction unit 111: image rendering size of where no anti-aliasing processing is to be performed.

In the anti-aliasing processing section 120 the pixels to which anti-aliasing processing is to be performed and the pixels to which no anti-aliasing processing is to be performed are managed based on the above 6 types of data and on the slope data curslope of the set line segment, the slope data curvslope of the orthogonal line segments, computes the image rendering pixel coordinates, the image rendering size and the ratios, and outputs these in sequence.

Specifically, a computation status management circuit 121 manages whether or not pixels for image rendering are on one or other of the four parallel line segments, or whether or not they are pixels to which no anti-aliasing processing is to be performed. An image rendering pixel counter 122 counts the number of pixels that have been image rendered. A ratio computation unit 123 computes a ratio from the coordinates of a pixel to which anti-aliasing processing is to be performed and from the slope of the line segment. An image rendering range processing unit 124 performs processing to determine whether or not the current image rendering line is in the image rendering range.

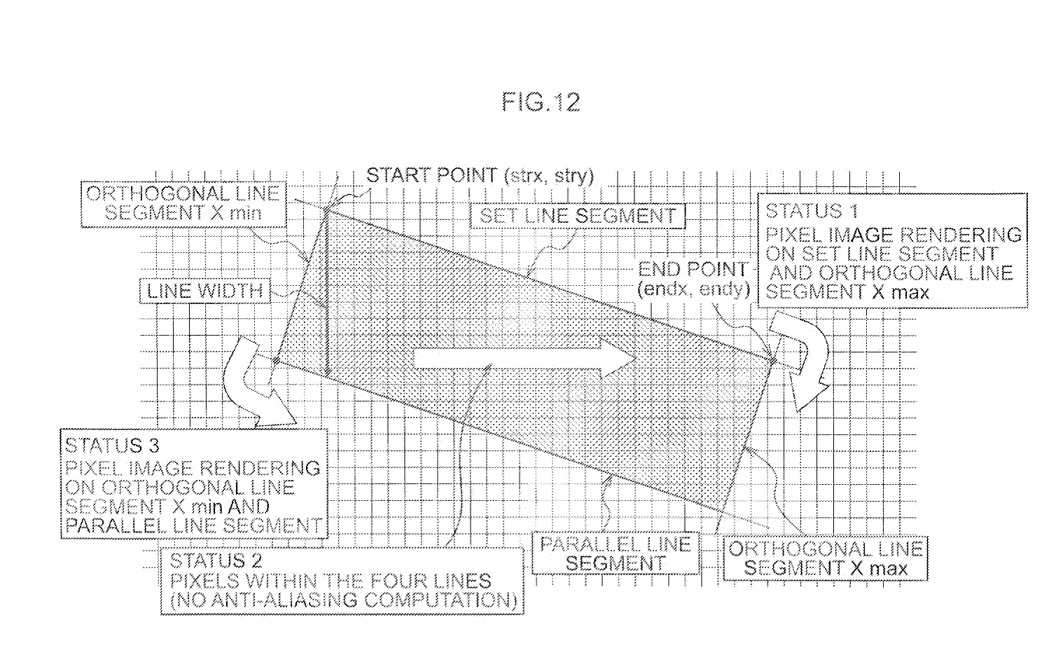

For example, when image rendering a straight line as shown in FIG. 12, there is a status 1 when image rendering pixels on the set line segment and on the orthogonal line segment X max, a status 3 when image rendering pixels on the orthogonal line segment X min and on the parallel line segment, and a status 2 when image rendering pixels to which no anti-aliasing processing is to be performed. Determination can be made as to whether or not the pixels to be image rendered in status 3 are on the orthogonal line segment X min or on the parallel line segment by whether the image rendering end point of the orthogonal line segment has become smaller or not than the image rendering end point of the parallel line segment. Determination can be made as to whether or not the pixels to be image rendered in status 1 are on the set line segment or on the orthogonal line segment X max by whether or not the image rendering start point of the set line segment has become larger than the image rendering start point of the orthogonal line segment X max. Image rendering completion can be determined by whether or not all of the overall image rendering start point has become larger than the overall image rendering end point.

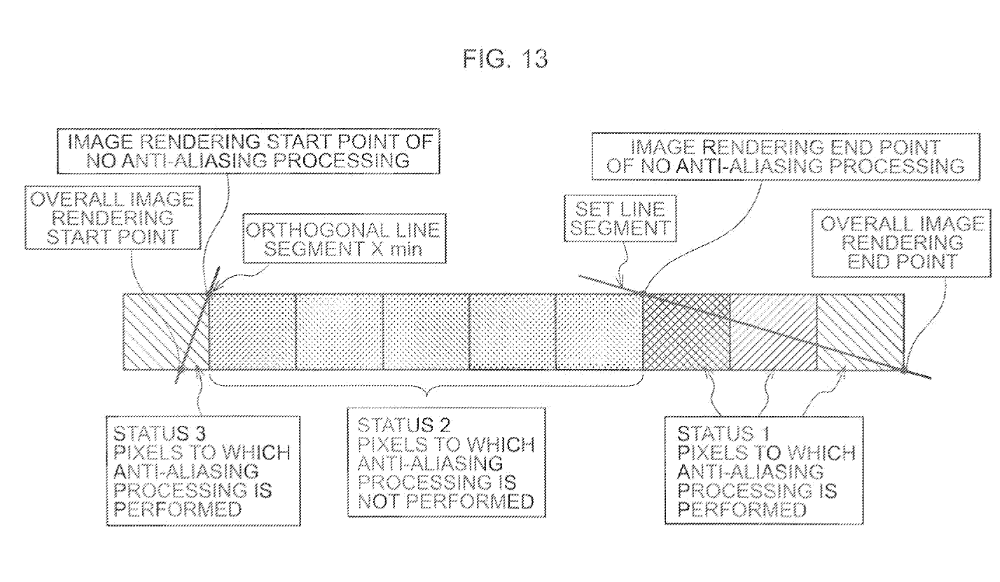

FIG. 13 shows a diagram in which the pixels of one image rendering line to be image rendered have been extracted. The image rendering pixel sequence is image rendered from left to right.

First, the overall image rendering start point coordinate is loaded into the image rendering pixel counter 122. Since there is a difference between the overall image rendering start point and the image rendering start point of where no anti-aliasing processing is to be performed. status 3 is set for the pixels on the orthogonal line segment X min. When the coordinate of the image rendering pixel=the image rendering pixel count value, the slope of the orthogonal line segment is passed to the ratio computation unit 123 and the ratio calculated. The calculated ratio is output as ratio, and the image rendering pixel count value is output as rndstrp. When this is being undertaken, since these are pixels for performing anti-aliasing processing, the rndsize is “1”.

Next, since the value of the image rendering pixel count+1 matches the image rendering start point of where no anti-aliasing processing is to be performed, status 2 is selected and the image rendering pixel count is incremented by 1. For the pixels to which no anti-aliasing processing is to be performed a value representing a ratio of 100% (for example 0) is output as ratio, and the image rendering size to which no anti-aliasing processing is to be performed is output as rndsize, and the image rendering pixel count value is output as rndstrp.

Next, image rendering of status 2 is completed, and since the pixels are on the orthogonal line segment X max, status 1 is set, and the image rendering pixel count becomes that of the image rendering pixel start point on the set line segment by adding the image rendering size of where no anti-aliasing processing is to be performed to the image rendering pixel count. The value of the image rendering pixel count and the slope of the set line segment is passed to the ratio computation unit 123 and the ratio is calculated. The ratio that is calculated is output as ratio, and the image rendering pixel count value is output as rndstrp and image rendering pixel size rndsize output as “1”.

The image rendering pixel count value is incremented by 1, and in a similar manner the ratio is calculated and output. This is repeated until the image rendering pixel count+1 is the overall image rendering end point, completing line image rendering on one scan line.

By the above status management and image rendering pixel count control, straight line image rendering having a line width and that has been anti-aliasing processed is made possible by repeatedly carrying out anti-aliasing processing for each of the image rendering lines.

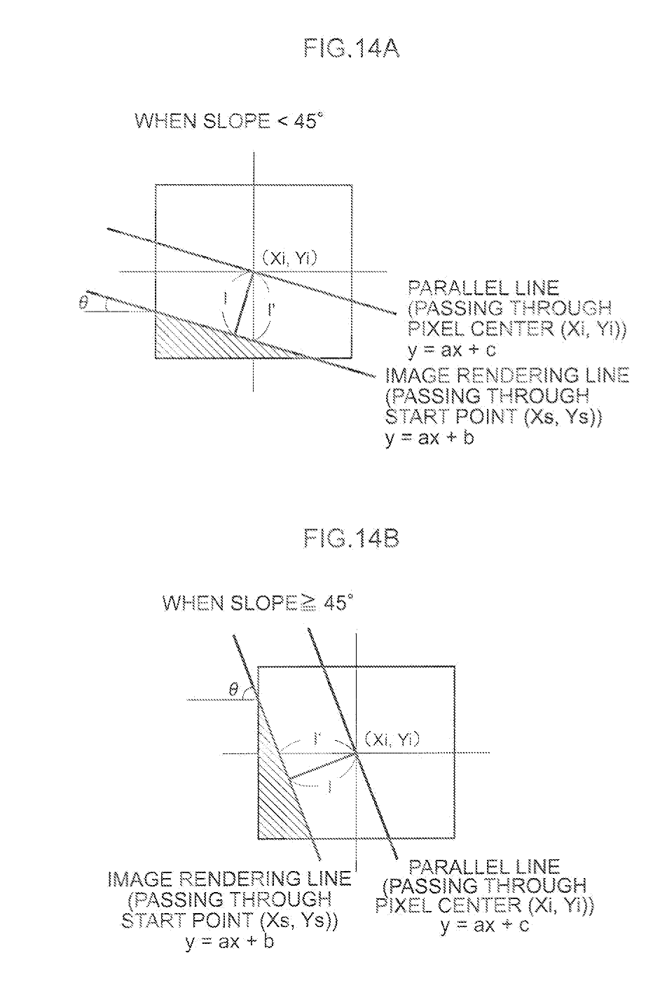

The ratio computation is, as shown in FIG. 14A and FIG. 148, a computation formula split at a slope of 45°. If the set line segment of the line segment to be image rendered is written as y=ax+b, then the density of the color of each of the pixels is determined by the surface area of the shaded portion that overhangs the line. When the set line segment passes through the center of a pixel, the ratio of the surface area of the shaded portion becomes 50%. However, as shown in FIG. 14A and FIG. 14B, computation is made such that the density becomes less dense the more the set line segment is either below or to the left of the center of the pixel, and the density becomes more dense the more the set line segment is either above or to the right of the center of the pixel. When a line parallel to the set line segment and passing through the center of the pixel is written as y=ax+c, if the distance from the center of the pixel to the set line segment is I, and the distance from the center of the pixel to the position at which the set line segment crosses a vertical line or a horizontal line is I′, then:

when the slope <45°

$$\begin{matrix}\begin{matrix}{I}^{′} = c - b \\ = ( Yi - aXi ) - ( Ys - aXs ) \\ = ( Yi - Ys ) - a ( Xi - Xs )\end{matrix} & \\ I = {I}^{′} cos θ = cos θ \times \{ ( Yi - Ys ) - a ( Xi - Xs ) \} & \end{matrix}$$

when the slope ≧45°

$$\begin{matrix}\begin{matrix}{I}^{′} = - c / a - b ( - b / a ) \\ = ( Xi - Yi / a ) - ( Xs - Ys / a ) \\ = ( Xi - Xs ) - 1 / a ( Yi - Ys )\end{matrix} & \\ I = {I}^{′} cos θ = cos θ \times \{ ( Xi - Xs ) - 1 / a ( Yi - Ys ) \} . & \end{matrix}$$

Here, when the distance from the center of the pixel is represented by 5 bits (−32 gradations), if the set line segment passes through the center of the pixel then the ratio is 50% (the center in 5 bits is 16), and so

when the slope <45°

distance[4:0]=16±n×{(Yi−Ys)−a(Xi−Xs)}

and when the slope ≧45°

distance[4:0]=16±n×{(Xi−Xs)−1/a(Yi−Ys)}.

Integrating cos θ between 0° and 45°, and taking a weighted average at 45°:

$$\begin{matrix}n = 32 \times sin {45}^{∘} / ( π / 4 ) \\ = 64 / ( π \times \sqrt{2} ) \\ = 28.8\end{matrix}$$

When fraction less than an integer are rounded up this becomes cos θ≈29, and the ratio in the present exemplary embodiment is derived in by the following.

When the slope <45°

the ratio=16±29{(Yi−Ys)−a(Xi−Xs)}

and when the slope ≧45°

the ratio=16±29{(Xi−Xs)−1/a(Yi−Ys)}.

The above computation uses a multiplier unit with only the multiplier of the slope, and since ×29 is a simple multiplication, this can be executed by shift computation and addition and subtraction computation.

As long as Xs and Ys are coordinates of a pixel such that the ratio becomes 50% they may be anywhere. In FIGS. 14A and 14B when the pixel is on the set line segment and on the orthogonal line segment X min they are the coordinates of the start point, when the pixel is on the orthogonal line segment X max they are the coordinates of the end point, and when the pixel is on the parallel line segment they are the coordinates of the pixel a line width's worth vertically down from the start point.

In the above manner, according to the present exemplary embodiment, any increase in circuit scale and any reduction in image rendering speed can be suppressed by deriving, based on the image rendering parameters, the image rendering region one at a time for each of the image rendering lines configured by plural pixels configuring an image. In addition, since the density of a pixel is determined for each of the pixels of each of the image rendering lines, according to the ratio occupied by the image rendering region with respect to the pixel region and according to the density of the image rendering region, any jaggedness can be made so as not to stand out.

In the present exemplary embodiment, the set line segment, the parallel line segment, the orthogonal line segment X min (first orthogonal line segment) and the orthogonal line segment X max (second orthogonal line segment) are derived, and since anti-aliasing processing is only performed to pixels through which any of the edges of the rectangular region, which is surrounded by the set line segment, the parallel line segment, the orthogonal line segment X min and the orthogonal line segment X max, pass, any reduction in image rendering processing due to the anti-aliasing processing is suppressed.

Furthermore, according to the present exemplary embodiment, for the pixels to which anti-aliasing processing is performed, since computation of the ratio of pixel color for performing anti-aliasing image rendering is performed with a computation formula that changes at a boundary of image rendering straight line slope at 45°, image rendering data is passed to later circuits one pixel at a time, and the image rendering data of pixels to which no anti-aliasing processing is to be performed are grouped together in a similar manner to conventionally and passed to later circuits, an effect is obtained in that straight line image rendering to which anti-aliasing processing has been carried out is possible, while suppressing any increase in circuit scale and any reduction in image rendering speed.

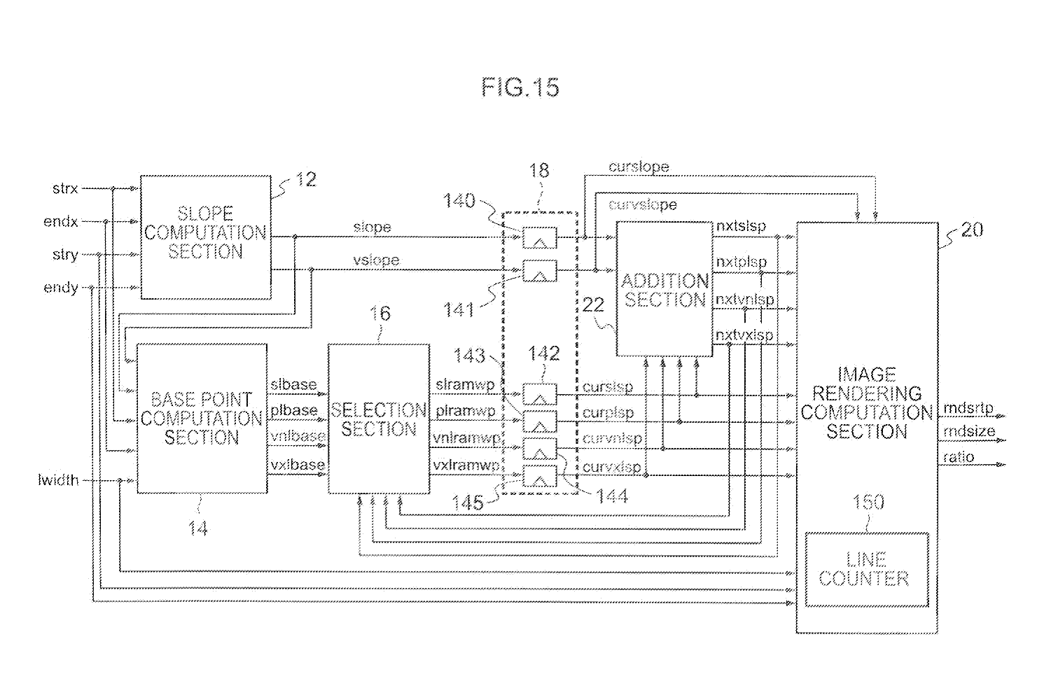

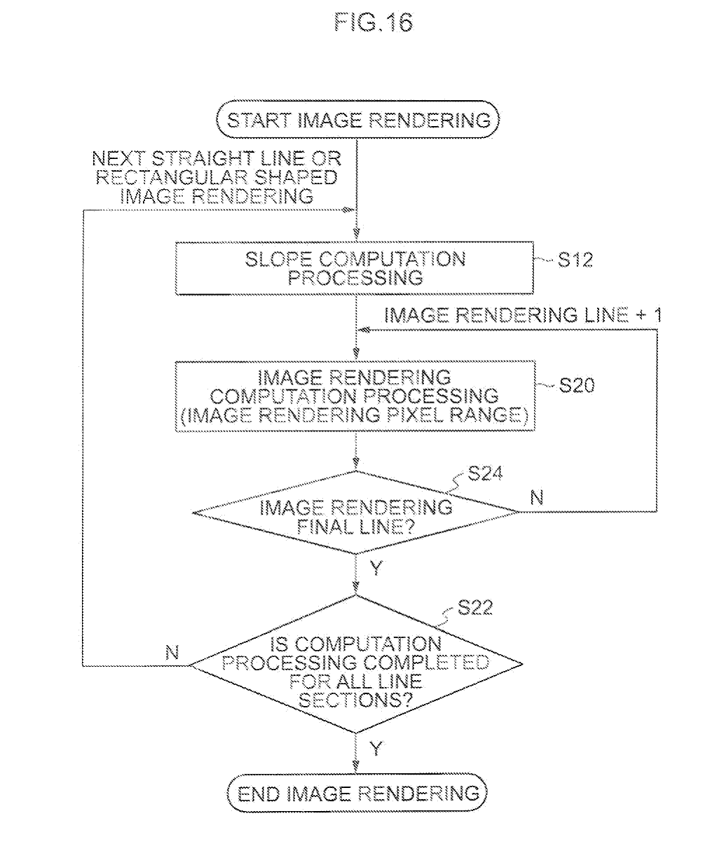

It should be noted that while explanation has been given in the above exemplary embodiment of an example where the memory used for image holding at a later stage is configured by a line buffer, application can also be made to a configuration, as shown in FIG. 15, with respective storage sections of the memory section 18 configured from registers 140, 141, 142, 143, 144, and 145, a line counter 150 further provided to the image rendering computation section 20 of the configuration of the above exemplary embodiment, and a later stage image holding memory 32 configured by a frame memory. FIG. 16 shows an example of an image rendering flow diagram when using a frame memory mode.

In the above exemplary embodiment, in the frame memory mode as shown in FIG. 16, image rendering computation can be performed more immediately after slope computation in comparison to separate execution of the slope computation and the image rendering computation, as shown in FIG. 9. Hence, since there is no need to hold plural straight lines worth of straight line slope and start point data, the RAM can be used as a register. It should be noted that since in the frame memory mode operation is made irrespective of the display device, there is no need for internal provision of a counter of scan line data.

Also, in the above exemplary embodiment, explanation has been give on a case in which the present disclosure is applied to an image rendering computation circuit 10 that renders image rendering lines of a given width, however the present disclosure is no limited thereto. For example, the present disclosure may be applied to an image rendering computation circuit 10 that performs image rendering of various geometric shapes, such as circles or the like. While in the present exemplary embodiment the range data representing the image rendering range is given by start points, end points and line widths, the present disclosure is not limited thereto. For example, when image rendering a circle the range data is the center point, radius and the like.

Also, explanation has been given in the above exemplary embodiment of a case of image rendering a high density image rendering region in which the density of the pixels increases the higher the proportion occupied by the image rendering region. However, configuration may be made such that when, for example, image rendering a low density image rendering region the density of the pixels decreases the higher the proportion occupied by the image rendering region.

In addition, while explanation has been given in the above exemplary embodiment of a case where the computation formula for determining the density changes at 45°, the present disclosure is not limited thereto. Configuration may be made such that the computation formula for determining the density changes at another angle other than 45°, or at plural angles.

The configuration of the image rendering computation circuit 10 explained in the above exemplary embodiment (see FIGS. 1 to 7 and FIG. 15) is only an example, and obviously appropriate variations and modifications may be made within a scope not departing from the spirit of the present disclosure.

Furthermore, the processing flow of the computation explained in the above exemplary embodiment (see FIG. 9) is also only an example thereof, and obviously appropriate variations and modifications may be made within a scope not departing from the spirit of the present disclosure.

Following from the above description and embodiment, it should be apparent to those of ordinary skill in the art that, while the foregoing constitutes an exemplary embodiment of the present disclosure, the disclosure is not necessarily limited to this precise embodiment and that changes may be made to this embodiment without departing from the scope of the invention as defined by the claims. Additionally, it is to be understood that the invention is defined by the claims and it is not intended that any limitations or elements describing the exemplary embodiment set forth herein are to be incorporated into the interpretation of any claim element unless such limitation or element is explicitly stated. Likewise, it is to be understood that it is not necessary to meet any or all of the identified advantages or objects of the disclosure discussed herein in order to fall within the scope of any claims, since the invention is defined by the claims and since inherent and/or unforeseen advantages of the present disclosure may exist even though they may not have been explicitly discussed herein.

What is claimed is:

1. An image rendering processing apparatus comprising:
a deriving section that, based on range data representing an image rendering range for performing image rendering, derives an image rendering region for each image rendering line configured by a plurality of pixels configuring an image;
a determination section that, for each pixel in each of the image rendering lines,
determines the density of the pixel according to the ratio of the image rendering region relative to the pixel region and according to the density of the image rendering region.

2. The image rendering processing apparatus of claim 1, wherein when the density of the image rendering region is high the determination section raises the density as the ratio gets the higher, and when the density of the image rendering region is low the determination section lowers the density as the ratio gets higher.

3. The image rendering processing apparatus of claim 1, wherein:
when the image to be rendered is an image rendering line segment of a specific width, the range data includes a start point and an end point of a line segments representing an edge of the outer boundary of the image rendering line segment, and a line width with respect to the edge; and
the deriving section derives a set line segment passing through the start point and the end point, a parallel line segment that is parallel to the set line segment and is positioned by the line width from the start point, a first orthogonal line segment that passes through the start point and intersects orthogonally with the set line segment, and a second orthogonal line segment that passes through the end point and intersects orthogonally with the set line segment, and for each image rendering line derives, as an image rendering region, a rectangular region surrounded by the set line segment, the parallel line segment, the first orthogonal line segment and the second orthogonal line segment.

4. The image rendering processing apparatus of claim 3, wherein the determination section only performs computation to determine the density of the pixel, according to the ratio occupied of the image rendering region relative to the pixel region and according to the density of the image rendering region, for the pixels through which one or other of the sides of the rectangular region pass.

5. The image rendering processing apparatus of claim 4, wherein, for pixels through which one or other of the sides of the rectangular region pass, the determination section changes a computation formula for determining the density of the pixels according to the angle of the side that passes through the pixel relative to the image rendering line.
